(19) United States
(12) Patent Application Publication
(10) Pub. No.: US 2026/0081536 A1
(43) Pub. Date: Mar. 19, 2026

(54) POWER CONVERTER

(71) Applicant: Infineon Technologies Austria AG, Villach (AT)

(72) Inventors: Alex MIRTCHEV, Villach (AT); Manuel ESCUDERO RODRIGUEZ, Wien (AT); Matteo-Alessandro KUTSCHAK, Ludmannsdorf (AT)

(21) Appl. No.: 18/888,577

(22) Filed: Sep. 18, 2024

(51) Int. Cl. H02M 5/293; H02M 1/44; H02M 7/217

(52) U.S. Cl. CPC H02M 5/2932; H02M 1/44; H02M 7/217

(57) ABSTRACT

A method comprises, in a single-phase mode, connecting a first switching leg and a second switching leg to a first phase line of a single-phase source, connecting a third switching leg and a fourth switching leg to a neutral line of the single-phase source, and controlling switching of the first switching leg, the second switching leg, the third switching leg, and the fourth switching leg to generate an output signal at a high side terminal and a low side terminal, and, in a three-phase mode, connecting the first switching leg to a first phase line of a three-phase source, connecting the second switching leg to a second phase line of the three-phase source, connecting the third switching leg to a third phase line of the three-phase source, and controlling switching of the first switching leg, the second switching leg, and the third switching leg to generate the output signal.

### TECHNICAL FIELD

The present disclosure relates to the field of regulated power conversion.

### BACKGROUND

Various types of devices may utilize electric power converters that convert one form of electric energy to another, such as by changing a voltage of the electric energy. In a battery charging application, alternating current (AC) power may be converted to direct current (DC) power.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to some embodiments, a power converter apparatus comprises a matrix power converter, comprising a high side terminal, a low side terminal, a first switching leg connected to the high side terminal, the low side terminal, and a first line, a second switching leg connected to the high side terminal, the low side terminal, and a second line, a third switching leg connected to the high side terminal, the low side terminal, and a third line, a fourth switching leg connected to the high side terminal, the low side terminal, and a fourth line, and a control engine configured to, in a single-phase mode, connect the first line and the second line to a first phase line of a single-phase source, connect the third line and the fourth line to a neutral line of the single-phase source, and control switching of the first switching leg, the second switching leg, the third switching leg, and the fourth switching leg to generate an output signal at the high side terminal and the low side terminal, and, in a three-phase mode, connect the first line to a first phase line of a three-phase source, connect the second line to a second phase line of the three-phase source, connect the third line to a third phase line of the three-phase source, and control switching of the first switching leg, the second switching leg, and the third switching leg to generate the output signal.

According to some embodiments, a power converter apparatus comprises a matrix power converter, comprising a high side terminal, a low side terminal, a first high side switch connected to the high side terminal and a first line, a first low side switch connected to the low side terminal and the first line, a second high side switch connected to the high side terminal and a second line, a second low side switch connected to the low side terminal and the second line, a third high side switch connected to the high side terminal and a third line, and a third low side switch connected to the low side terminal and the third line, and a control engine configured to, in a single-phase mode, connect the first line and the second line to a first phase line of a single-phase source and control switching of the first high side switch, the first low side switch, the second high side switch, and the second low side switch to generate an output signal at the high side terminal and the low side terminal, and, in a three-phase mode, connect the first line to a first phase line of a three-phase source, connect the second line to a second phase line of the three-phase source, connect the third line to a third phase line of the three-phase source, and control switching of the first high side switch, the first low side switch, the second high side switch, the second low side switch, the third high side switch, and the third low side switch to generate the output signal.

According to some embodiments, a method for controlling a power converter apparatus comprises, in a single-phase mode, connecting a first switching leg and a second switching leg to a first phase line of a single-phase source, connecting a third switching leg and a fourth switching leg to a neutral line of the single-phase source, and controlling switching of the first switching leg, the second switching leg, the third switching leg, and the fourth switching leg to generate an output signal at a high side terminal and a low side terminal, and, in a three-phase mode, connecting the first switching leg to a first phase line of a three-phase source, connecting the second switching leg to a second phase line of the three-phase source, connecting the third switching leg to a third phase line of the three-phase source, and controlling switching of the first switching leg, the second switching leg, and the third switching leg to generate the output signal.

According to some embodiments, a system for controlling a power converter apparatus comprises, in a single-phase mode, means for connecting a first switching leg and a second switching leg to a first phase line of a single-phase source, means for connecting a third switching leg and a fourth switching leg to a neutral line of the single-phase source, and means for controlling switching of the first switching leg, the second switching leg, the third switching leg, and the fourth switching leg to generate an output signal at a high side terminal and a low side terminal, and, in a three-phase mode, means for connecting the first switching leg to a first phase line of a three-phase source, means for connecting the second switching leg to a second phase line of the three-phase source, means for connecting the third switching leg to a third phase line of the three-phase source, and means for controlling switching of the first switching leg, the second switching leg, and the third switching leg to generate the output signal.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 a diagram of a power converter apparatus, in accordance with some embodiments.

FIG. 2 is a diagram of a supply connector, in accordance with some embodiments.

FIG. 3 is a diagram of an electromagnetic interference (EMI) filter, in accordance with some embodiments.

FIG. 4 is a diagram of a matrix power converter, a tank circuit, and an isolation circuit, in accordance with some embodiments.

FIGS. 5 and 6 are diagrams of a configurable output stages, in accordance with some embodiments.

FIG. 7 illustrates a method for controlling a multi-level power converter, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by "about" or "approximately" the indicated value, and take into account experimental error and variations that would be expected by a person having ordinary skill in the art.

The term "power converter apparatus" and/or the like as used herein broadly refers to any type of power converter or voltage regulator (VR) that provides one or more regulated voltages to one or more electronic loads such as an Ethernet switch, an Ethernet router, an ASIC (application-specification integrated circuit), a memory device, a processor such as a central processing unit (CPU), a microprocessor, a graphics processing unit (GPU), a digital signal processor (DSP), an artificial intelligence (AI) accelerator, an image processor, a network or packet processor, a coprocessor, a multi-core processor, a front-end processor, a baseband processor, a field programmable gate array (FPGA), a lighting element, a power tool, a vehicle, a motor, or some other suitable load.

The term “power converter apparatus” and/or the like as used herein means a functional assembly, such as a packaged functional assembly or a combination of one or more printed circuit boards and/or discrete components, that includes a regulated power converter including a switching circuit used in converting a voltage from one level to another level, e.g., as in power conversion, power factor correction, and voltage regulation. The power converter apparatus may also include a driver circuit for driving the switching circuit. The power converter apparatus may additionally include a control engine for controlling the driver circuit so as to implement the power converter. The control engine may be configured to control the regulated power converter to reduce a voltage error of the output voltage, such as a difference between the output voltage and a target voltage, to control a current error of the output current, such as a difference between the output current and a target current, to provide power factor correction, or some other power conversion function.

The power converter apparatus supply power, to a DC load, such as a battery, a supercapacitor, or some other DC load, at an output of the power converter apparatus in a grid connected embodiment (i.e., AC/DC conversion). Alternatively, the regulated power converter may act as an inverter to convert a DC power supply to generate an AC signal to power an AC load (i.e. DC/AC conversion). The control engine and/or driver functionality may instead be implemented outside the power converter apparatus. Driver circuits for switching circuits in the power converter apparatus also may be outside the power converter apparatus. Various passive components such as capacitors and/or inductors may be included in the power converter apparatus, surface mounted to the power converter apparatus, located on a separate board, etc.

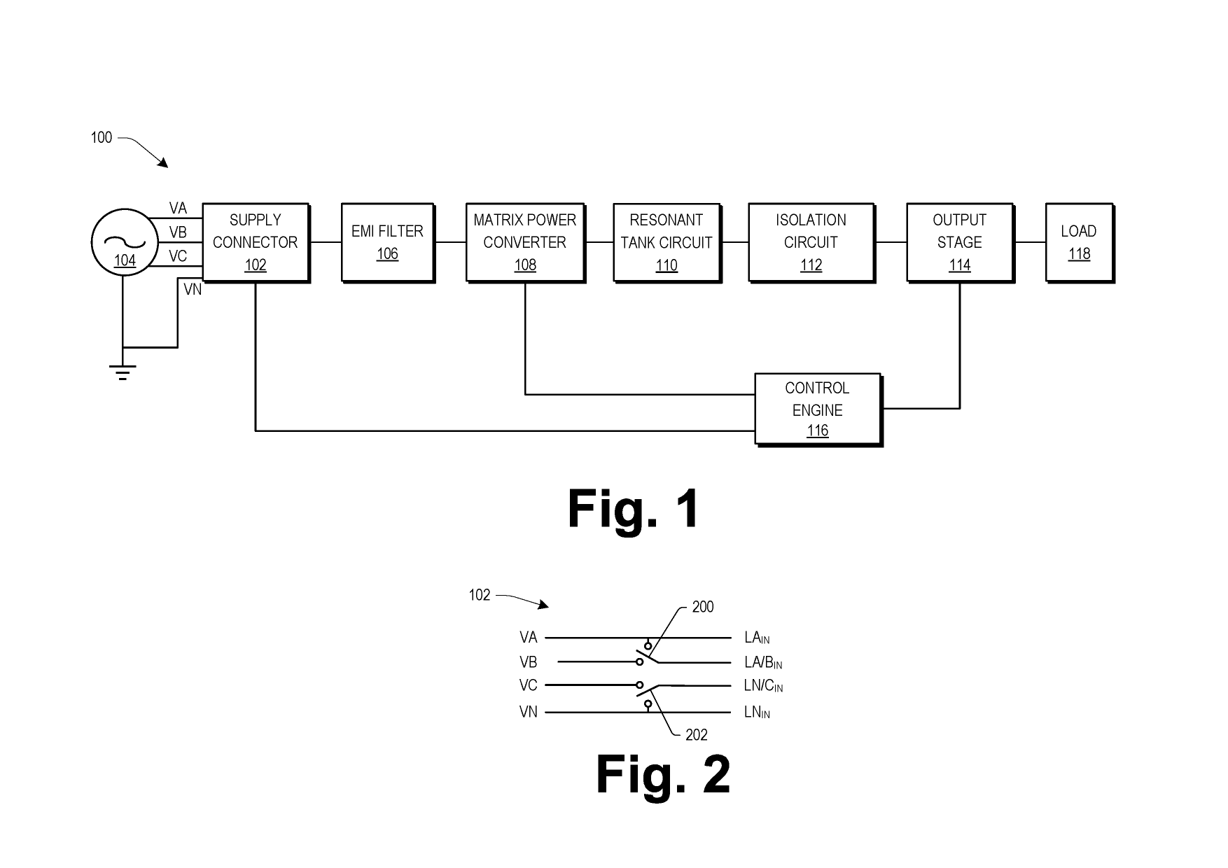

Referring to FIG. 1 a diagram of a power converter apparatus 100 is provided, in accordance with some embodiments. The power converter apparatus 100 comprises a supply connector 102 connected to a power supply 104, an EMI filter 106 connected to the supply connector 102, a matrix power converter 108 connected to the EMI filter 106, a resonant tank circuit 110 connected to the matrix power converter 108, an isolation circuit 112 connected to the resonant tank circuit 110, an output stage 114 connected to the isolation circuit 112, and a control engine 116 configured to generate control signals for configuring the supply connector 102 and controlling the matrix power converter 108 and the output stage 114 to power a load 118. The load 118 may be a battery, a supercapacitor, or some other DC load.

In some embodiments, the power converter apparatus 100 controls and/or regulates an output voltage and/or an output current for the load 118. The power converter apparatus 100 may control the output voltage at the output to match a target voltage and/or the power converter apparatus 100 may be configured to reduce a voltage error of the output voltage. The voltage error may correspond to a difference between the output voltage and the target voltage. In a current control mode, the power converter apparatus 100 may control the output current provided to the load 118 based on a target current or a maximum current. In some embodiments, the power converter apparatus 100 may switch between voltage control modes and current control modes.

In some embodiments, the power supply 104 may be a single-phase AC supply or a three-phase AC supply. In FIG. 1, the power supply 104 is illustrated as a three-phase AC supply with VA, VB, VC, and VN outputs. In a three-phase AC supply, the VN output may not be present. In a single-phase AC supply, the VB and VC outputs are not be present. The control engine 116 controls the supply connector 102 based on the type of power supply 104 connected.

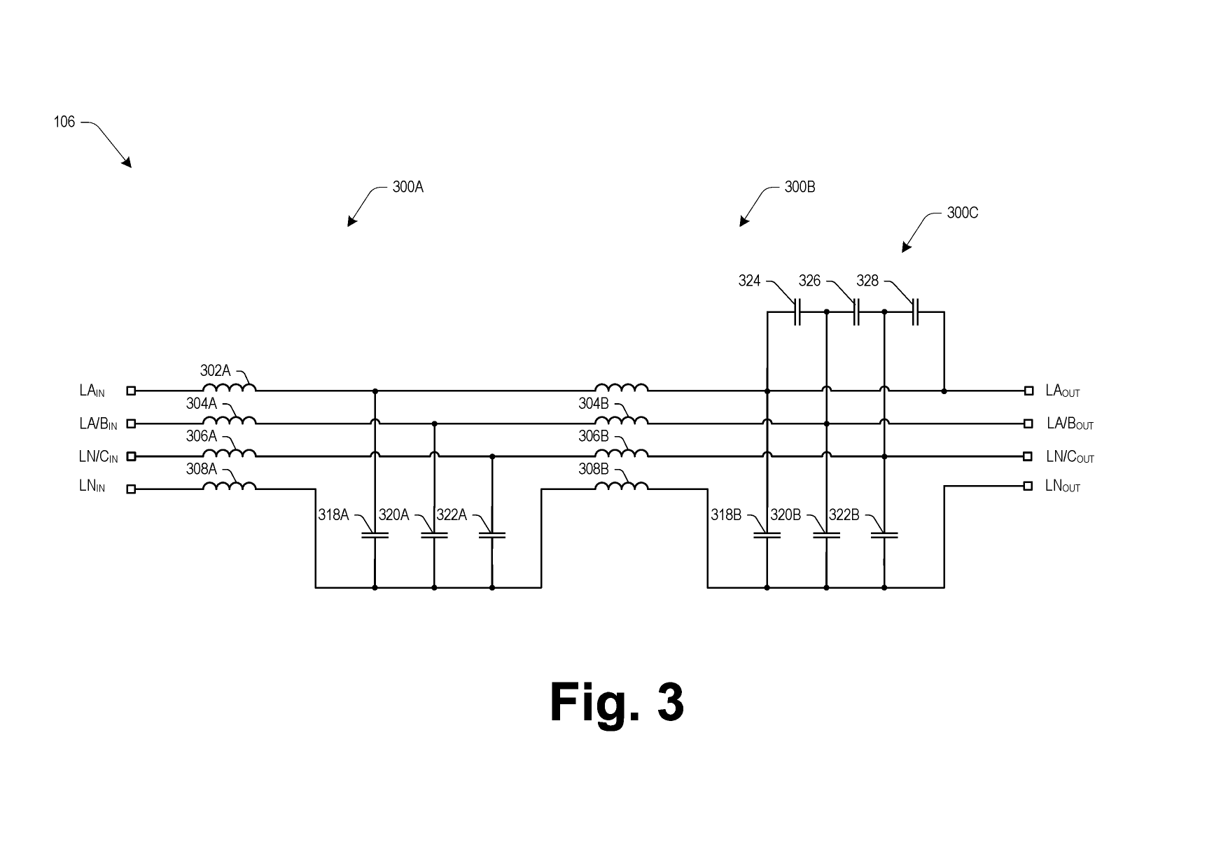

FIG. 2 is a diagram of the supply connector 102, in accordance with some embodiments. The supply connector comprises switches 200, 202 for connecting the VA, VB, VC, and VN outputs of the power supply 104 to input lines LA, LB, LC, LN for the EMI filter 106 based on the configuration of the power supply 104. The switches 200, 202 may be relays external to a circuit board comprising other components of the power converter apparatus 100 or the switches 200, 202 may be implemented using transistors included on the circuit board. For a three-phase configuration of the power supply 104, the switches 200, 202 are configured to route VA to LA_{IN}, VB to LA/B_{IN}, and VC to LN/C_{IN}. Depending on the power supply 104, VN and LN_{IN} may be a ground reference or not connected. For a single-phase configuration of the power supply 104, the switches 200, 202 are configured to route VA to LA_{IN}, VA to LA/B_{IN}, and VN to LN/C_{IN}.

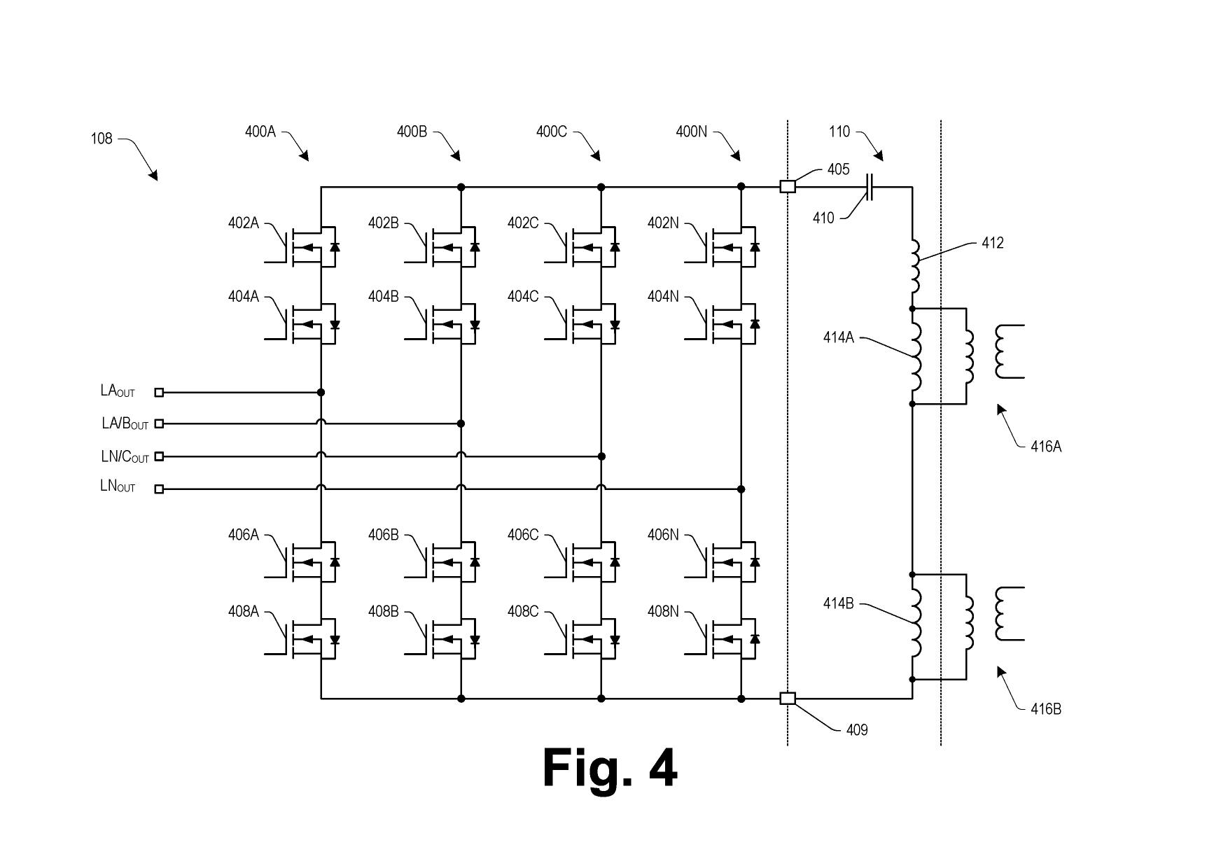

FIG. 3 is a diagram of the EMI filter 106, in accordance with some embodiments. In some embodiments, the EMI filter 106 comprises LC stages 300A, 300B and a phase-to-phase stage 300C. In some embodiments, the LC stage 300A may be omitted. The LC stage 300A comprises filter inductors 302A, 304A, 306A, 308A connected to the LA_{IN}, LA/B_{IN}, LN/C_{IN}, and LN_{IN} lines, respectively. Phase-to-neutral capacitors 318A, 320A, 322A, are connected (i.e., Y-connected) to the lines for the phases (LA_{IN}, LA/B_{IN}, LN/C_{IN}).

The LC stage 300B comprises filter inductors 302B, 304B, 306B, 308B connected to the LA_{IN}, LA/B_{IN}, LN/C_{IN}, and LN_{IN} lines, respectively. Phase-to-neutral capacitors 318B, 320B, 322B are connected (i.e., Y-connected) to the output lines for the phases (LA_{OUT}, LA/B_{OUT}, LN/C_{OUT}). In some embodiments, one of the LC stages 300A, 300B may be omitted or additional LC stages may be added.

In some embodiments, the phase-to-phase stage 300C comprises series capacitors 324, 326, 328 connected (i.e., X-connected) to the output lines for the phases (LA_{OUT}, LA/B_{OUT}, LN/C_{OUT}). For example, the capacitor 324 is connected to the LA_{OUT} line, the capacitor 326 is connected in series with the capacitor 326, and the node between the capacitors 324, 326 is connected to the LA/B_{OUT} line, and the capacitor 328 is connected in series with the capacitor 326, the node between the capacitors 326, 328 is connected to the LN/C_{OUT} line, and the capacitor 328 is connected to the LA_{OUT} line.

The EMI filter 106 provides unity power factor (PF) and EMI noise suppression. For three-phase operation the neutral-line is normally absent with zero current. The EMI filter 106 is symmetrical with two series connected LC stages with the capacitors in Y-connection. For single-phase operation all four lines LA_{IN}, LA/B_{IN}, LN/C_{IN}, LN_{IN} are active and are in parallel by two (i.e., LA_{IN} and LA/B_{IN}, are connected to VA and LN/C_{IN} and LN_{IN}. are connected to VN). In some embodiments, the X-connected series capacitors 324, 326, 328 account for asymmetry in the capacitances between LA_{IN}, LA/B_{IN}, LN/C_{IN}, LN_{IN} to avoid high frequency ripple flowing in the LN path which would cause increased RMS current.

The X-connected series capacitors 324, 326, 328 provide a capacitive path from the two phase-lines LA_{OUT}, LA/B_{OUT} to both the neutral lines LN/C_{OUT}, LN_{OUT} resulting in equal filtering. Lower AC currents flow through the connected series capacitors 324, 326, 328 capacitors due to distribution of the high-frequency current. Consequently, grid-side filtering is improved with very small difference between the neutral lines LN/C_{OUT}, LN_{OUT}. Another advantage is that the current stress of the filter inductors 302A, 304A, 306A, 308A, 302B, 304B, 306B, 308B is reduced due to the parallel operation and is even in all four lines. The capacitors 324, 322B do not contribute substantially to the EMI filtering in single-phase operation circuit, however, they are employed for three-phase operation. Hence, the EMI filter 106 is compatible with both single-phase and three-phase operating modes.

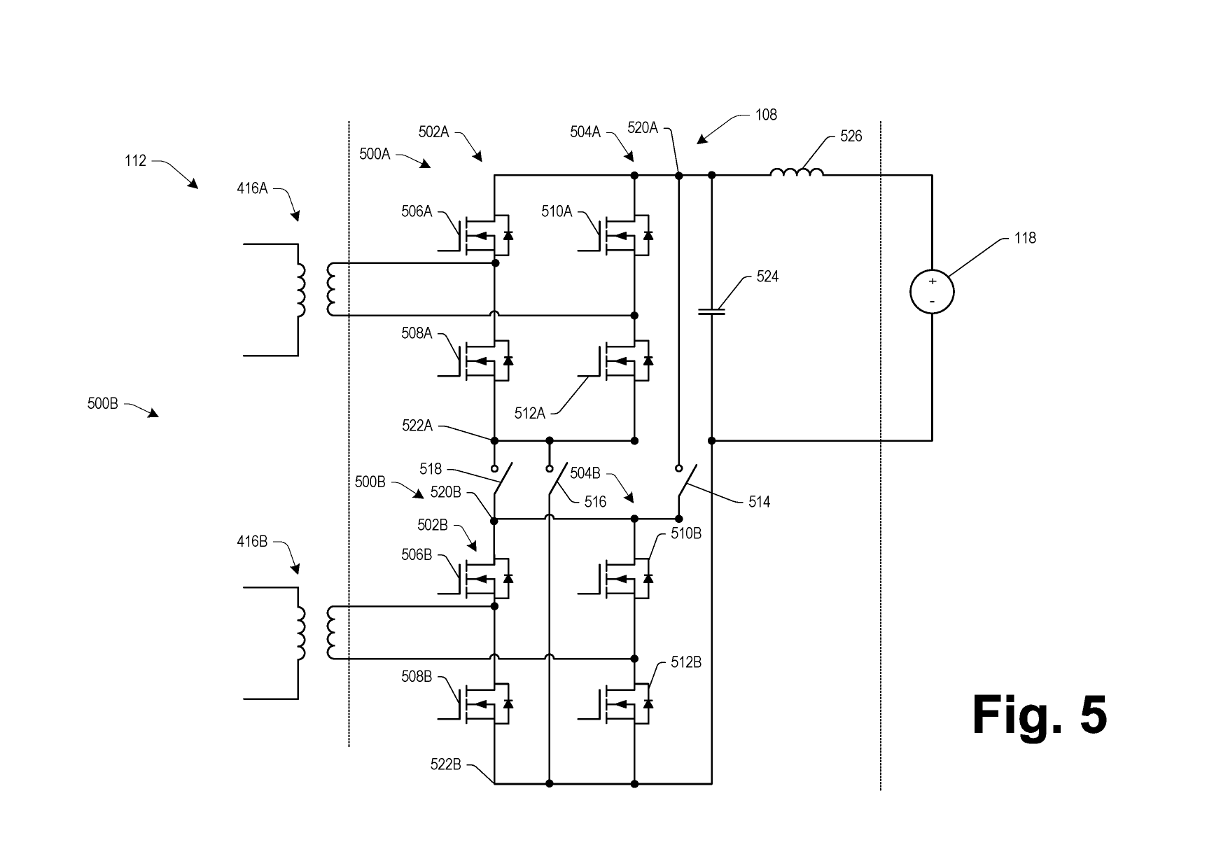

FIG. 4 is a diagram of the matrix power converter 108, the resonant tank circuit 110, and the isolation circuit 112 in accordance with some embodiments. In some embodiments, the matrix power converter 108 comprises four switching legs 400A, 400B, 400C, 400N connected to the four lines LA_{OUT}, LA/B_{OUT}, LN/C_{OUT}, LN_{OUT}, respectively. Each switching leg 400A, 400B, 400C, 400N comprises high side complementary switch pairs 402A/404A, 402B/404B, 402C/404C, 402N/404N connected to a high side terminal 405 of the matrix power converter 108 and complementary low side switch pairs 406A/408A, 406B/408B, 406C/408C, 406N/408N connected to a low side terminal 409 of the matrix power converter 108. In some embodiments, each high side complementary switch pair 402A/404A, 402B/404B, 402C/404C, 402N/404N and each complementary low side switch pair 406A/408A, 406B/408B, 406C/408C, 406N/408N are implemented using single bidirectional switches.

In some embodiments, the resonant tank circuit 110 comprises a resonant capacitor 410 connected to the high side terminal 405 of the matrix power converter 108, a resonant inductor 412, and one or more primary inductors 414A, 414B. Alternatively, the resonant capacitor 410 may be connected to the low side terminal 409. The isolation circuit 112 comprises one or more isolation transformers 416A, 416B connected in parallel with the primary inductors 414A, 414B. The primary inductors 414A, 414B may be discrete components or may represent the magnetizing inductance of the isolation transformers 416A, 416B, respectively. In the embodiment of FIG. 4, the resonant tank circuit 110 is configured to support a multi-stage configurable output stage 114. In some embodiments, where the output stage 114 is a single stage embodiment, the isolation transformer 416B and the primary inductors 414B may be omitted.

In some embodiments, the power converter apparatus 100 the converter operates as a PFC unit and a battery charger for the load 118, minimizing output current ripple and protecting the load 118 from current that could exceed maximum load current. In some embodiments, for the three-phase operation, only the switching legs 400A, 400B, 400C are actively switching to generate a line-to-line voltage for the resonant tank circuit 110, thus achieving the minimum voltage variation on the envelope of the high-frequency (HF) voltage. The fourth switching leg 400N is inactive. In some embodiments, the fourth switching leg 400N is used to create more levels in the HF voltage (e.g., 6 or 7) if the neutral, VN, is supplied by the power supply 104.

For single-phase operation, the switching legs 400A, 400B share the phase-line (VA) and the switching legs 400C, 400N share the neutral-line (VN). This configuration results in current sharing in the switching legs 400A, 400B, 400C, 400N, a significant advantage considering that the input voltage may be lower in single-phase operation compared to the three-phase operation. Additional capacitors are not required for power pulsating techniques. One switch 402A, 404A, 402B, 404B, 402C, 404C, 402N, 404N, 406A, 408A, 406B, 408B, 406C, 408C, 406N, 408N in each switch pair operates at low frequency based on the sign of the grid-voltage and the other switch 402A, 404A, 402B, 404B, 402C, 404C, 402N, 404N, 406A, 408A, 406B, 408B, 406C, 408C, 406N, 408N in each switch pair operates at high frequency to generate the required excitation for the resonant tank circuit 110. For single phase operation the legs 400A and 400B are controlled in the same manner (in parallel) and the legs 400C and 400N are controlled in the same manner. Thus, for the positive half-cycle the switches 402A/B, 408A/B, 404C/N, 406C/N are always ON (low frequency operation) and the switches 404A/B, 406A/B, 402C/N, 408C/N are switching (high frequency operation).

For each positive and negative half cycle of the grid-voltage, the switches 402A, 404A, 402B, 404B, 402C, 404C, 402N, 404N, 406A, 408A, 406B, 408B, 406C, 408C, 406N, 408N change from one operating state to the other. The legs 400A, 400B operate at the same frequency and phase. For example, for the switching legs 400A, 400C during the positive half cycle, the switches 402A, 404C, 406C, 408A switch at low frequency and the switches 404A, 402C, 406A, 408C operate at high frequency based on a PWM signal. Conversely, for the switching legs 400A, 400C during the negative half cycle, the switches 402A, 404C, 406C, 408A switch according to the PWM signal and the switches 404A, 402C, 406A, 408C operate at low frequency. Similar to three-phase operation, zero voltage switching is provided as long as the zero-crossing (ZC) of the square-wave AC voltage at the output leads the ZC of the corresponding AC current. Having half of the switches operating at low frequency reduces switching losses.

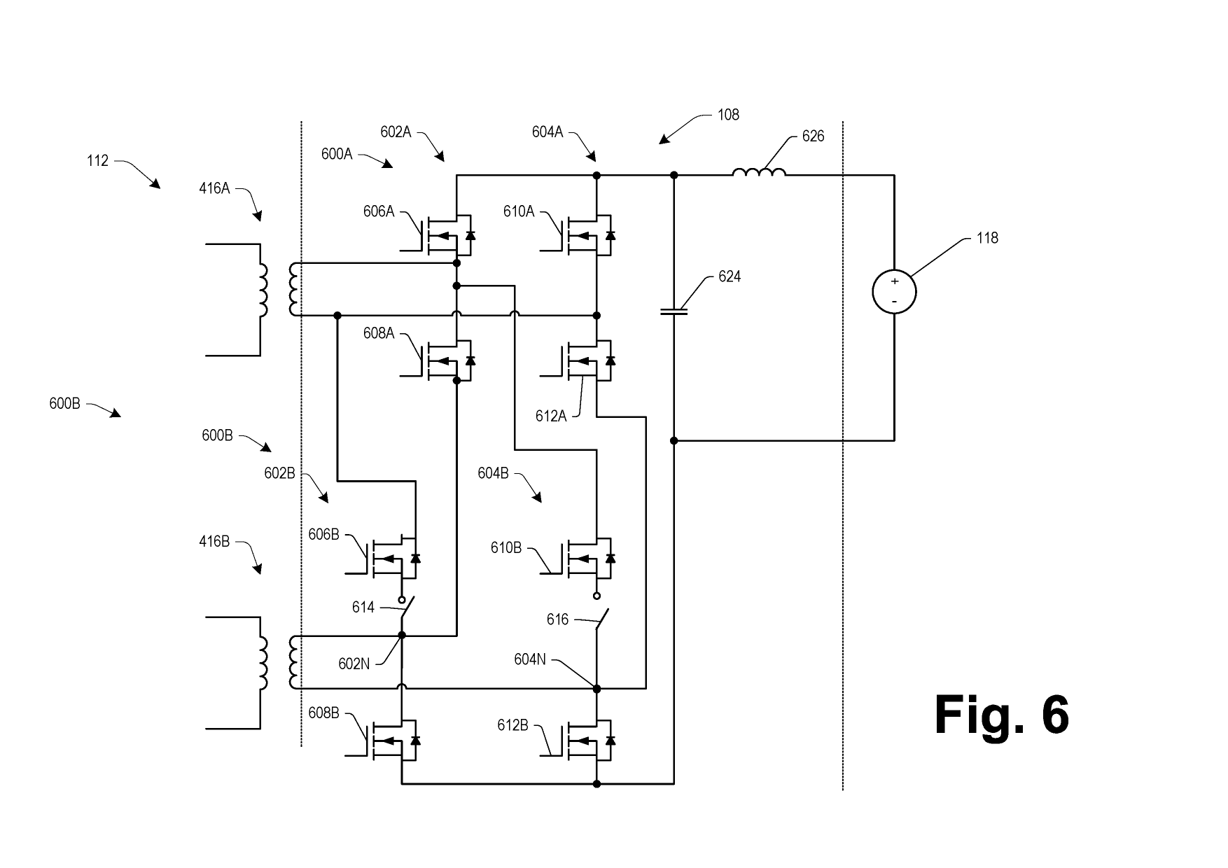

FIG. 5 is a diagram of the output stage 114, in accordance with some embodiments. In some embodiments, the output stage 114 is configurable to provide sufficient regulation range to accommodate variable battery voltage and charging current associated with the load 118. In some embodiments, the output stage 114 is configurable based on whether the power converter apparatus 100 is operating in constant current (CC) or constant voltage (CV) modes to reduce the frequency range and the primary-side circulating current.

In some embodiments, the output stage 114 comprises a first rectifier stage 500A and a second rectifier stage 500B. In some embodiments, the first rectifier stage 500A comprises a first leg 502A connected to the high side of the isolation transformer 416A and a second leg 504A connected to a low side of the isolation transformer 416A. The first leg 502A comprises a high side switch 506A and a low side switch 508A connected at a node to the high side of the isolation transformer 416A. The second leg 504A comprises a high side switch 510A and a low side switch 512A connected at a node to the low side of the isolation transformer 416A.

In some embodiments, the second rectifier stage 500B comprises a first leg 502B connected to the high side of the isolation transformer 416B and a second leg 504B connected to a low side of the isolation transformer 416B. The first leg 502B comprises a high side switch 506B and a low side switch 508B connected at a node to the high side of the isolation transformer 416B. The second leg 504B comprises a high side switch 510B and a low side switch 512B connected at a node to the low side of the isolation transformer 416B.

A switch 514 connects a high node 520A of the first rectifier stage 500A to a high node 520B of the second rectifier stage 500B. A switch 516 connects a low node 522A of the first rectifier stage 500A to a low node 522B of the second rectifier stage 500B. A switch 518 connects a low node 522A of the first rectifier stage 500A to the high node 520B of the second rectifier stage 500B. The switches 514, 516, 518 may be relays or transistors.

In some embodiments, an output capacitor 524 is connected to the high node 520A of the first rectifier stage 500A and to the low node 522B of the second rectifier stage 500B. An output inductor 526 is connected between the output capacitor 524 and the load 118.

The control engine 116 controls the switches 514, 516, 518 depending on the mode (CC or CV) of the power converter apparatus 100. In CC mode, the rectifier stages 500A, 500B are connected in parallel by closing the switches 514, 516 and opening the switch 518. The power converter apparatus 100 may operate as a step-up converter or a step-down converter. The current is distributed in the two rectifier stages 500A, 500B, thus reducing the conduction losses.

In CV mode, the rectifier stages 500A, 500B are connected in series by closing the switch 518 and opening the switches 514, 516. The power converter apparatus 100 operates as an alternating current solid state transformer (ACX) with constant average voltage ratio. Due to the changing input voltage, in CV mode the converter operates in both buck and boost modes around the resonance point.

In some embodiments, where two stages are not required for the output stage, the second rectifier stage 500B is omitted, and the low node 522A is connected directly to the load 118.

FIG. 6 is a diagram of an alternative output stage 114, in accordance with some embodiments. In some embodiments, the output stage 114 comprises a first rectifier stage 600A and a second rectifier stage 600B. In some embodiments, the first rectifier stage 600A comprises a first leg 602A connected to the high side of the isolation transformer 416A and a second leg 604A connected to a low side of the isolation transformer 416A. The first leg 602A comprises a high side switch 606A and a low side switch 608A connected at a node to the high side of the isolation transformer 416A. The low side switch 608A is connected to the high side of the isolation transformer 416B. The second leg 604A comprises a high side switch 610A and a low side switch 612A connected at a node to the low side of the isolation transformer 416A. The low side switch 612A is connected to the low side of the isolation transformer 416B.

In some embodiments, the second rectifier stage 600B comprises a first leg 602B connected to the low side of the isolation transformer 416A and a second leg 604B connected to the high side of the isolation transformer 416A. The first leg 602B comprises a high side switch 606B and a low side switch 608B connected at a node 602N to the high side of the isolation transformer 416B. The second leg 604B comprises a high side switch 610B and a low side switch 612B connected at a node 604N to the low side of the isolation transformer 416B. A switch 614 is connected between the high side switch 606B and the node 602N. A switch 616 is connected between the high side switch 610B and the node 604N. The switches 614, 616 may be relays, back-to-back transistor devices, or bi-directional switches.

In some embodiments, an output capacitor 624 is connected across the rectifier stages 600A, 600B. An output inductor 626 is connected between the output capacitor 624 and the load 118.

The control engine 116 controls the switches 614, 616 depending on the mode (CC or CV) of the power converter apparatus 100. In CC mode, the rectifier stages 600A, 600B are connected in parallel by opening the switches 614, 616, thereby isolating the high side switches 606B, 610B in the second rectifier stage 600B and connecting the low side switches 608B, 612B in the second rectifier stage 600B in series with the low side switches 608A, 612A in the first rectifier stage 600A. Current flows through the switches 606A, 608A, 612A, 612B during a positive AC cycle and through the switches 608A, 608B, 610A, 612A during a negative AC cycle.

In CV mode, the switches 614, 616 are closed, thereby connecting the high side switch 606B to the node 602N and connecting the high side switch 610B to the node 604N. Current flows through the switches 606A, 606B, 612B during a positive AC cycle and through the switches 610A, 608B, 610B during a negative AC cycle.

For three-phase operation an envelope for the excitation is constructed off the resonant tank circuit 110 with minimum ripple. Output voltage regulation is achieved via pulse frequency modulation (PFM) of the primary-side pulses applied to the matrix power converter 108. The resonant tank circuit 110 is configured to cover the charging profile of the load 118 (i.e., battery stack), starting from the minimum voltage with maximum current and reaching the maximum voltage for the same current. After CC mode, the power converter apparatus 100 enters CV mode where the output voltage is kept constant but the current decreases up to 10% of the nominal value. The power converter apparatus 100 may operate in buck and boost modes, only in buck mode, or only in boost mode.

The configurable output stages of FIGS. 5 and 6 allows the power converter apparatus 100 to operate as close as possible to the resonance point to increase the efficiency over the charging spectrum. By changing the connection of the rectifier stages 500A, 500B, 600A, 600B from parallel to series for CC and CV modes, respectively, the operating frequency range is narrow and the current and voltage stress of the primary-side is reduced across the charging spectrum. Paralleling the rectifier stages 500A, 500B, 600A, 600B during high output current operation reduces conduction losses.

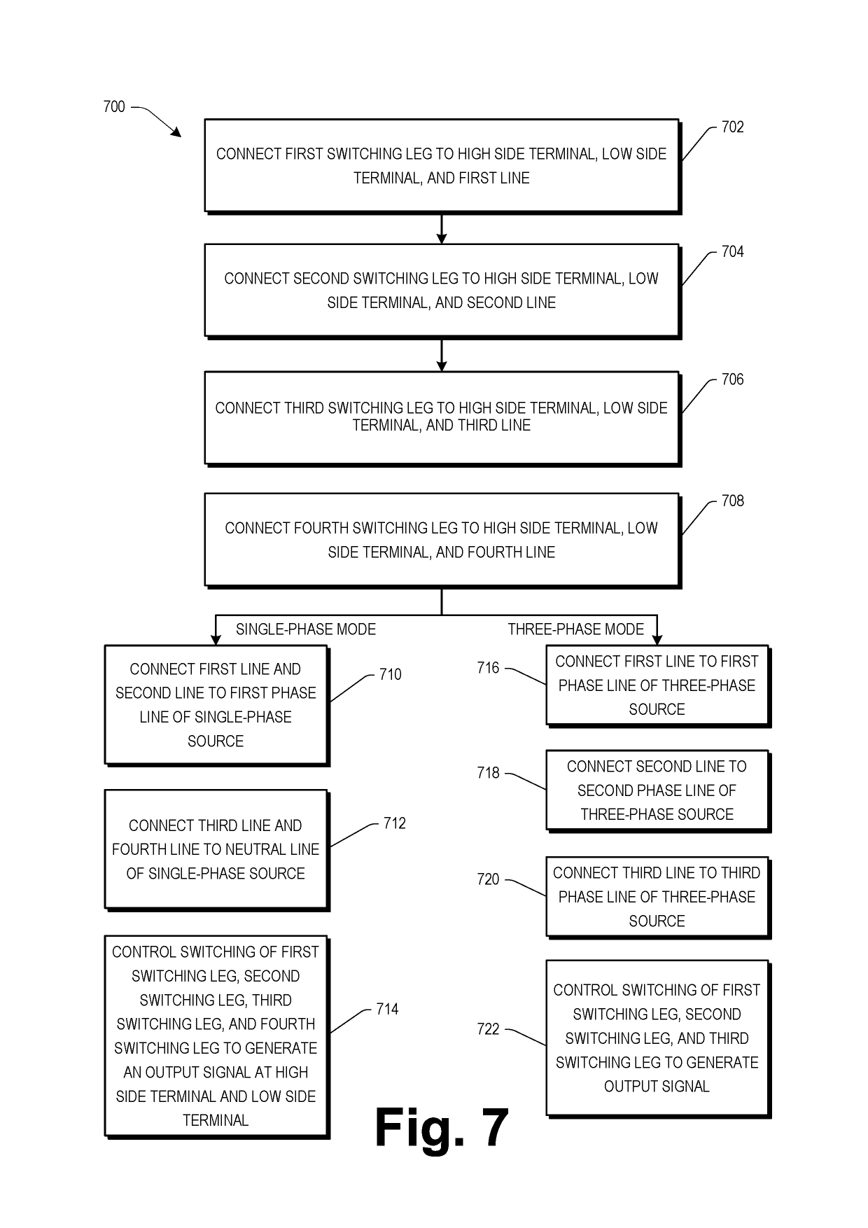

FIG. 7 illustrates a method 700 for controlling a multi-level power converter, in accordance with some embodiments. At 702 a first switching leg 400A is connected to a high side terminal 405, a low side terminal 400, and a first line. At 704, a second switching leg 400B is connected to a high side terminal 405, a low side terminal 409, and a second line. At 706, a third switching leg 400C is connected to the high side terminal 405, the low side terminal 409, and a third line. At 708 a fourth switching leg 400N is connected to the high side terminal 405, the low side terminal 409, and a fourth line. In a single-phase mode, at 720 the first line and the second line are connected to a first phase line of a single-phase source. At 712, the third line and the fourth line are connected to a neutral line of the single-phase source. At 714 switching of the first switching leg 400A, the second switching leg 400B, the third switching leg 400C, and the fourth switching leg 400N is controlled to generate an output signal at the high side terminal and the low side terminal. In a three-phase mode, at 716, the first line is connected to a first phase line of a three-phase source. At 718, the second line is connected to a second phase line of the three-phase source. At 720, the third line is connected to a third phase line of the three-phase source. At 722, switching of the first switching leg 400A, the second switching leg 400B, and the third switching leg 400C is controlled to generate the output signal.

According to some embodiments, a power converter apparatus comprises a matrix power converter, comprising a high side terminal, a low side terminal, a first switching leg connected to the high side terminal, the low side terminal, and a first line, a second switching leg connected to the high side terminal, the low side terminal, and a second line, a third switching leg connected to the high side terminal, the low side terminal, and a third line, a fourth switching leg connected to the high side terminal, the low side terminal, and a fourth line, and a control engine configured to, in a single-phase mode, connect the first line and the second line to a first phase line of a single-phase source, connect the third line and the fourth line to a neutral line of the single-phase source, and control switching of the first switching leg, the second switching leg, the third switching leg, and the fourth switching leg to generate an output signal at the high side terminal and the low side terminal, and, in a three-phase mode, connect the first line to a first phase line of a three-phase source, connect the second line to a second phase line of the three-phase source, connect the third line to a third phase line of the three-phase source, and control switching of the first switching leg, the second switching leg, and the third switching leg to generate the output signal.

According to some embodiments, the control engine is configured to connect the fourth leg to a neutral line of the three-phase source in the three-phase mode and control switching of the fourth leg to generate the output signal.

According to some embodiments, the first switching leg comprises a high side switch connected to a first node and the high side terminal and a low side switch connected to the first node and the low side terminal, and the control engine is configured to control switching of the first switching leg by controlling switching of the high side switch and the low side switch.

According to some embodiments, the first switching leg comprises a first high side switch connected to a first node, a second high side switch connected to the first node and the high side terminal, a first low side switch connected to a second node, and a second low side switch connected to the second node and the low side terminal, and the control engine is configured to control switching of the first switching leg by switching one of the first high side switch or the second high side switch at a first frequency, switching the other of the first high side switch or the second high side switch at a second frequency higher than the first frequency, switching one of the first low side switch or the second low side switch at the first frequency, and switching the other of the first low side switch or the second low side switch at the second frequency.

According to some embodiments, the power converter apparatus comprises an electromagnetic interference filter comprising a first filter stage connected to the first line, a second filter stage connected to the second line, a third filter stage connected to the third line, a fourth filter stage connected to the fourth line, a first capacitor connected to the first line and the second line, a second capacitor connected to the second line and the third line, and a third capacitor connected to the third line and the first line.

According to some embodiments, the first filter stage comprises a first inductor connected to the first line and a first capacitor connected to the first inductor and the fourth line.

According to some embodiments, the first filter stage comprises a second inductor connected to the first inductor and a second capacitor connected to the second inductor and the fourth line.

According to some embodiments, the power converter apparatus comprises a resonant tank circuit connected to the matrix power converter, an isolation circuit connected to the resonant tank circuit, and an output stage connected to the isolation circuit.

According to some embodiments, the output stage comprises a first rectifier stage and a second rectifier stage, the control engine is configured to connect the first rectifier stage in parallel with the second rectifier stage in a constant current mode, and the control engine is configured to connect the first rectifier stage in series with the second rectifier stage in a constant voltage mode.

According to some embodiments, the power converter apparatus comprises a supply connector, comprising a first switch having a first input connected to the first phase line, a second input connected to the second phase line, and an output connected to the second line, and a second switch having a first input connected to the third phase line, a second input connected to the neutral line, and an output connected to the third line, wherein, in the single-phase mode, the control engine is configured to connect the first input of the first switch to the output of the first switch and connect the second input of the second switch to the output of the second switch.

According to some embodiments, a power converter apparatus comprises a matrix power converter, comprising a high side terminal, a low side terminal, a first high side switch connected to the high side terminal and a first line, a first low side switch connected to the low side terminal and the first line, a second high side switch connected to the high side terminal and a second line, a second low side switch connected to the low side terminal and the second line, a third high side switch connected to the high side terminal and a third line, and a third low side switch connected to the low side terminal and the third line, and a control engine configured to, in a single-phase mode, connect the first line and the second line to a first phase line of a single-phase source and control switching of the first high side switch, the first low side switch, the second high side switch, and the second low side switch to generate an output signal at the high side terminal and the low side terminal, and, in a three-phase mode, connect the first line to a first phase line of a three-phase source, connect the second line to a second phase line of the three-phase source, connect the third line to a third phase line of the three-phase source, and control switching of the first high side switch, the first low side switch, the second high side switch, the second low side switch, the third high side switch, and the third low side switch to generate the output signal.

According to some embodiments, the matrix power converter comprises a fourth high side switch connected to the high side terminal and a fourth line and a fourth low side switch connected to the low side terminal and the fourth line, and the control engine is configured to, in the single-phase mode, connect the third line and the fourth line to a neutral line of the single-phase source and control switching of the fourth high side switch and the fourth low side switch to generate the output signal.

According to some embodiments, the power converter apparatus comprises an electromagnetic interference filter comprising a first filter stage connected to the first line, a second filter stage connected to the second line, a third filter stage connected to the third line, a fourth filter stage connected to the fourth line, a first capacitor connected to the first line and the second line, a second capacitor connected to the second line and the third line, and a third capacitor connected to the third line and the first line.

According to some embodiments, the first filter stage comprises a first inductor connected to the first line and a first capacitor connected to the first inductor and the fourth line.

According to some embodiments, the power converter apparatus comprises a resonant tank circuit connected to the matrix power converter, an isolation circuit connected to the resonant tank circuit, and an output stage connected to the isolation circuit, wherein the output stage comprises a first rectifier stage and a second rectifier stage, the control engine is configured to connect the first rectifier stage in parallel with the second rectifier stage in a constant current mode, and the control engine is configured to connect the first rectifier stage in series with the second rectifier stage in a constant voltage mode.

According to some embodiments, a method for controlling a power converter apparatus comprises, in a single-phase mode, connecting a first switching leg and a second switching leg to a first phase line of a single-phase source, connecting a third switching leg and a fourth switching leg to a neutral line of the single-phase source, and controlling switching of the first switching leg, the second switching leg, the third switching leg, and the fourth switching leg to generate an output signal at a high side terminal and a low side terminal, and, in a three-phase mode, connecting the first switching leg to a first phase line of a three-phase source, connecting the second switching leg to a second phase line of the three-phase source, connecting the third switching leg to a third phase line of the three-phase source, and controlling switching of the first switching leg, the second switching leg, and the third switching leg to generate the output signal.

According to some embodiments, the method comprises connecting the fourth switching leg to a neutral line of the three-phase source in the three-phase mode.

According to some embodiments, controlling switching of the first switching leg comprises controlling a high side switch connected to a first node and the high side terminal and controlling a low side switch connected to the first node.

According to some embodiments, the method comprises connecting an electromagnetic interference filter to the first switching leg, the second switching leg, the third switching leg, and the fourth switching leg, wherein the electromagnetic interference filter comprises a first filter stage connected to the first switching leg, a second filter stage connected to the second switching leg, a third filter stage connected to the third switching leg, a fourth filter stage connected to the fourth switching leg, a first capacitor connected to the first switching leg and the second switching leg, a second capacitor connected to the second switching leg and the third switching leg, and a third capacitor connected to the third switching leg and the first switching leg.

According to some embodiments, the method comprises connecting a resonant tank circuit to the high side terminal and the low side terminal, connecting an isolation circuit to the resonant tank circuit, connecting an output stage comprising a first rectifier stage and a second rectifier stage to the isolation circuit, connecting the first rectifier stage in parallel with the second rectifier stage in a constant current mode, and connecting the first rectifier stage in series with the second rectifier stage in a constant voltage mode.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an "example" is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term "or" is intended to mean an inclusive "or" rather than an exclusive "or". That is, unless specified otherwise, or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims may generally be construed to mean "one or more" unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms "includes", "having", "has", "with", or variants thereof are used in either the detailed description or the claims, such terms are intended to be inclusive in a manner similar to the term "comprising."

What is claimed is:

1. A power converter apparatus, comprising:
a matrix power converter, comprising:
a high side terminal;
a low side terminal;
a first switching leg connected to the high side terminal, the low side terminal, and a first line;
a second switching leg connected to the high side terminal, the low side terminal, and a second line;
a third switching leg connected to the high side terminal, the low side terminal, and a third line;
a fourth switching leg connected to the high side terminal, the low side terminal, and a fourth line; and
a control engine configured to:
in a single-phase mode:
connect the first line and the second line to a first phase line of a single-phase source;
connect the third line and the fourth line to a neutral line of the single-phase source; and
control switching of the first switching leg, the second switching leg, the third switching leg, and the fourth switching leg to generate an output signal at the high side terminal and the low side terminal; and
in a three-phase mode:
connect the first line to a first phase line of a three-phase source;
connect the second line to a second phase line of the three-phase source;
connect the third line to a third phase line of the three-phase source; and
control switching of the first switching leg, the second switching leg, and the third switching leg to generate the output signal.

2. The power converter apparatus of claim 1, wherein:
the control engine is configured to:
connect the fourth leg to a neutral line of the three-phase source in the three-phase mode and
control switching of the fourth leg to generate the output signal.

3. The power converter apparatus of claim 1, wherein:
the first switching leg comprises:
a high side switch connected to a first node and the high side terminal; and
a low side switch connected to the first node and the low side terminal; and
the control engine is configured to control switching of the first switching leg by controlling switching of the high side switch and the low side switch.

4. The power converter apparatus of claim 1, wherein:
the first switching leg comprises:
a first high side switch connected to a first node;
a second high side switch connected to the first node and the high side terminal;
a first low side switch connected to a second node; and
a second low side switch connected to the second node and the low side terminal; and
the control engine is configured to control switching of the first switching leg by:
switching one of the first high side switch or the second high side switch at a first frequency;
switching the other of the first high side switch or the second high side switch at a second frequency higher than the first frequency;
switching one of the first low side switch or the second low side switch at the first frequency; and
switching the other of the first low side switch or the second low side switch at the second frequency.

5. The power converter apparatus of claim 1, comprising:
an electromagnetic interference filter, comprising:
a first filter stage connected to the first line;
a second filter stage connected to the second line;
a third filter stage connected to the third line;
a fourth filter stage connected to the fourth line;
a first capacitor connected to the first line and the second line;
a second capacitor connected to the second line and the third line; and
a third capacitor connected to the third line and the first line.

6. The power converter apparatus of claim 5, wherein the first filter stage comprises:
a first inductor connected to the first line; and
a first capacitor connected to the first inductor and the fourth line.

7. The power converter apparatus of claim 6, wherein the first filter stage comprises:
a second inductor connected to the first inductor; and
a second capacitor connected to the second inductor and the fourth line.

8. The power converter apparatus of claim 1, comprising:
a resonant tank circuit connected to the matrix power converter;
an isolation circuit connected to the resonant tank circuit; and
an output stage connected to the isolation circuit.

9. The power converter apparatus of claim 8, wherein:
the output stage comprises:
a first rectifier stage; and
a second rectifier stage;
the control engine is configured to connect the first rectifier stage in parallel with the second rectifier stage in a constant current mode; and
the control engine is configured to connect the first rectifier stage in series with the second rectifier stage in a constant voltage mode.

10. The power converter apparatus of claim 1, comprising:
a supply connector, comprising:
a first switch having a first input connected to the first phase line, a second input connected to the second phase line, and an output connected to the second line; and
a second switch having a first input connected to the third phase line, a second input connected to the neutral line, and an output connected to the third line, wherein:
in the single-phase mode, the control engine is configured to:
connect the first input of the first switch to the output of the first switch; and
connect the second input of the second switch to the output of the second switch.

11. A power converter apparatus, comprising:
a matrix power converter, comprising:
a high side terminal;
a low side terminal;
a first high side switch connected to the high side terminal and a first line;
a first low side switch connected to the low side terminal and the first line;
a second high side switch connected to the high side terminal and a second line;
a second low side switch connected to the low side terminal and the second line;
a third high side switch connected to the high side terminal and a third line; and
a third low side switch connected to the low side terminal and the third line; and
a control engine configured to:
in a single-phase mode:
connect the first line and the second line to a first phase line of a single-phase source; and
control switching of the first high side switch, the first low side switch, the second high side switch, and the second low side switch to generate an output signal at the high side terminal and the low side terminal; and
in a three-phase mode:
connect the first line to a first phase line of a three-phase source;
connect the second line to a second phase line of the three-phase source;
connect the third line to a third phase line of the three-phase source; and
control switching of the first high side switch, the first low side switch, the second high side switch, the second low side switch, the third high side switch, and the third low side switch to generate the output signal.

12. The power converter apparatus of claim 11, wherein:
the matrix power converter comprises:
a fourth high side switch connected to the high side terminal and a fourth line; and
a fourth low side switch connected to the low side terminal and the fourth line; and
the control engine is configured to:
in the single-phase mode:
connect the third line and the fourth line to a neutral line of the single-phase source and
control switching of the fourth high side switch and the fourth low side switch to generate the output signal.

13. The power converter apparatus of claim 12, comprising:
an electromagnetic interference filter, comprising:
a first filter stage connected to the first line;
a second filter stage connected to the second line;
a third filter stage connected to the third line;
a fourth filter stage connected to the fourth line;
a first capacitor connected to the first line and the second line;
a second capacitor connected to the second line and the third line; and
a third capacitor connected to the third line and the first line.

14. The power converter apparatus of claim 13, wherein the first filter stage comprises:
a first inductor connected to the first line; and
a first capacitor connected to the first inductor and the fourth line.

15. The power converter apparatus of claim 11, comprising:
a resonant tank circuit connected to the matrix power converter;
an isolation circuit connected to the resonant tank circuit; and
an output stage connected to the isolation circuit, wherein:
the output stage comprises:
a first rectifier stage; and
a second rectifier stage;
the control engine is configured to connect the first rectifier stage in parallel with the second rectifier stage in a constant current mode; and
the control engine is configured to connect the first rectifier stage in series with the second rectifier stage in a constant voltage mode.

16. A method for controlling a power converter apparatus, comprising:
in a single-phase mode:
connecting a first switching leg and a second switching to a first phase line of a single-phase source;
connecting a third switching leg and a fourth switching leg to a neutral line of the single-phase source; and
controlling switching of the first switching leg, the second switching leg, the third switching leg, and the fourth switching leg to generate an output signal at a high side terminal and a low side terminal; and
in a three-phase mode:
connecting the first switching leg to a first phase line of a three-phase source;
connecting the second switching leg to a second phase line of the three-phase source;
connecting the third switching leg to a third phase line of the three-phase source; and
controlling switching of the first switching leg, the second switching leg, and the third switching leg to generate the output signal.

17. The method of claim 16, comprising:
connecting the fourth switching leg to a neutral line of the three-phase source in the three-phase mode.

18. The method of claim 16, wherein:
controlling switching of the first switching leg comprises:
controlling a high side switch connected to a first node and the high side terminal; and
controlling a low side switch connected to the first node.

19. The method of claim 16, comprising:
connecting an electromagnetic interference filter to the first switching leg, the second switching leg, the third switching leg, and the fourth switching leg, wherein:
the electromagnetic interference filter comprises:
a first filter stage connected to the first switching leg;
a second filter stage connected to the second switching leg;
a third filter stage connected to the third switching leg;
a fourth filter stage connected to the fourth switching leg;
a first capacitor connected to a first line and the second switching leg;
a second capacitor connected to the second switching leg and the third switching leg; and
a third capacitor connected to the third switching leg and the first switching leg.

20. The method of claim 16, comprising:
connecting a resonant tank circuit to the high side terminal and the low side terminal;
connecting an isolation circuit to the resonant tank circuit;
connecting an output stage comprising a first rectifier stage and a second rectifier stage to the isolation circuit;
connecting the first rectifier stage in parallel with the second rectifier stage in a constant current mode; and
connecting the first rectifier stage in series with the second rectifier stage in a constant voltage mode.
